(19) United States
(12) Patent Application Publication
(10) Pub. No.: US 2015/0012239 A1
(43) Pub. Date: Jan. 8, 2015

(54) MEASUREMENT APPARATUS AND MEASUREMENT METHOD

(71) Applicant: KABUSHIKI KAISHA TOSHIBA, Minato-ku (JP)

(72) Inventor: Yasuhiko ISHIBASHI, Yokkaichi-Shi (JP)

(73) Assignee: KABUSHIKI KAISHA TOSHIBA, Minato-ku (JP)

(21) Appl. No.: 14/021,127

(22) Filed: Sep. 9, 2013

Related U.S. Application Data
(60) Provisional application No. 61/842,216, filed on Jul. 2, 2013.

(51) Int. Cl. G01N 9/00

(52) U.S. Cl. CPC G01N 9/00
USPC 702/137

(57) ABSTRACT

In accordance with an embodiment, a measurement apparatus includes a stage to hold a substrate, an electromagnetic wave applying unit, a detector, and first and second calculation units. The electromagnetic wave applying unit generates electromagnetic waves and applies it to the substrate. The detector detects the electromagnetic waves scattered or reflected by the substrate and measure the intensity of the electromagnetic waves. The first calculation unit processes a signal from the detector to create a first reflectance profile, fit the first reflectance profile to a second reflectance profile prepared by a simulation, thereby calculating thickness and density of an analytic model which is set so that the periodic structure and the membranous structure are regarded as a single mixed layer. The second calculation unit calculates, from a sectional shape of the periodic structure and the calculated thickness and density, the density of the second material after a volume change.

### CROSS REFERENCE TO RELATED APPLICATIONS

This application is based upon and claims the benefit of U.S. provisional Application No. 61/842,216, filed on Jul. 2, 2013, the entire contents of which are incorporated herein by reference.

### FIELD

Embodiments described herein relate generally to a measurement apparatus and a measurement method.

### BACKGROUND

Circuit patterns are being miniaturized in semiconductor integrated circuits to achieve a higher performance. Accuracy required in the measurement of the circuit patterns has been increasingly strict along with the miniaturization of the circuit patterns.

For the achievement of the miniaturization, not only the management of shapes but also the management of parameters of materials is required. As the density of a material filling a trench in particular affects the shape in the subsequent process, there have been increasing demands for the management of the density.

The material filling the trench varies in density due to stress, and is therefore monitored in vain if the material has not yet filled the trench.

However, there has not yet been any suggestion for a technique to measure the density of the material that is filling.

### BRIEF DESCRIPTION OF THE DRAWINGS

In the accompanying drawings:

FIG. 1 is a block diagram showing the general configuration of a measurement apparatus according to one embodiment;

FIG. 2 is a plan view showing the relationship between the path of X-rays and the direction of a pattern;

FIG. 3 is a graph showing an example of a reflectance profile obtained by the application of X-rays to a sample including a periodic structure;

FIG. 4 shows an example of a sectional view of a sample used in Example 1 before fabrication;

FIG. 5 shows an example of a sectional view of the sample used in Example 1 after fabrication;

FIG. 6 is a diagram showing an example of an analytic model of a laminated membrane made up of even layers alone;

FIG. 7 is a diagram showing an analytic model set for the sample in Example 1;

FIG. 8 is a diagram showing a surface shape measured by a CD-SAXS;

FIG. 9 shows an example of a sectional view of a sample used in Example 2 before fabrication;

FIG. 10 shows an example of a sectional view of the sample used in Example 2 after fabrication;

FIG. 11 is a diagram showing an analytic model set for the sample in Example 2;

FIG. 12 is a flowchart showing a general procedure of a measurement method according to Embodiment 1; and

FIG. 13 is a flowchart showing a general procedure of a measurement method according to a second embodiment.

### DETAILED DESCRIPTION

In accordance with an embodiment, a measurement apparatus includes a stage configured to hold a substrate, a stage control unit, an electromagnetic wave applying unit, an angle control unit, a detector, and first and second calculation units. The substrate includes a periodic structure of a first material arranged in a direction horizontal to a main surface of the substrate, and a membranous structure which is made of a second material different from the first material to fill the periodic structure and which changes in volume in a depth direction in accordance with a process. The stage control unit is configured to control at least one of a position, height, and rotation angle of the stage. The electromagnetic wave applying unit is configured to generate electromagnetic waves and apply the electromagnetic waves to the substrate. The angle control unit is configured to control an incidence angle of the electromagnetic waves from the electromagnetic wave applying unit. The detector is configured to detect the electromagnetic waves scattered or reflected by the substrate and measure the intensity of the electromagnetic waves. The first calculation unit is configured to process a signal from the detector to create a first reflectance profile, fit the first reflectance profile to a second reflectance profile prepared by a simulation, thereby calculating thickness and density of an analytic model which is set so that the periodic structure and the membranous structure are regarded as a single mixed layer. The second calculation unit is configured to calculate, from a sectional shape of the periodic structure and the calculated thickness and density, the density of the second material after a volume change.

Hereinafter, several embodiments will be described with reference to the drawings. Like reference numerals are given to like parts in the drawings, and repeated explanations of these parts are appropriately omitted.

(A) Measurement Apparatus

(1) Apparatus Configuration

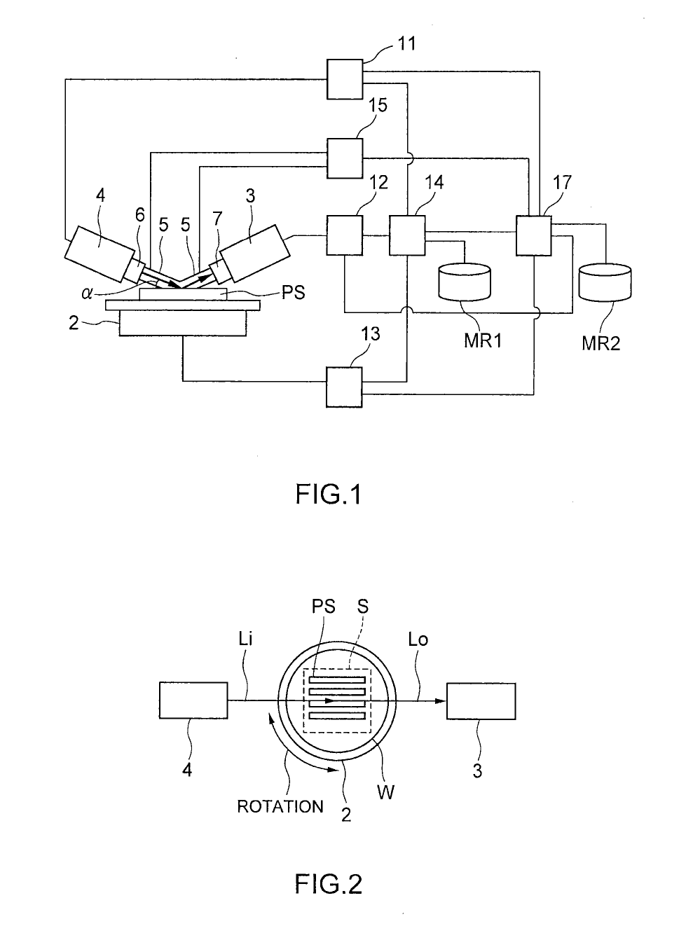

FIG. 1 is a block diagram showing the general configuration of a measurement apparatus according to one embodiment. The measurement apparatus according to the present embodiment has both a function for measurement by critical dimension small angle X-ray scattering (hereinafter referred to as “CD-SAXS measurement”) and a function for measurement by X-ray reflectometry (hereinafter referred to as “XRR measurement”).

More specifically, the measurement apparatus in FIG. 1 includes, as the main components, a stage 2, a stage controller 13, an X-ray tube 4, a light source controller 11, a goniometer 5, a goniometer controller 15, a monochromator 6, an attenuator 7, a two-dimensional detector 3, a data processor 12, a shape calculator 14, and a thickness/density calculator 17.

The X-ray tube 4 is connected to the shape calculator 14 and the thickness/density calculator 17 via the light source controller 11. The two-dimensional detector 3 is connected to the shape calculator 14 and the thickness/density calculator 17 via the data processor 12. The shape calculator 14 is also connected to the stage controller 13. The thickness/density calculator 17 is also connected to the goniometer controller 15 and the stage controller 13.

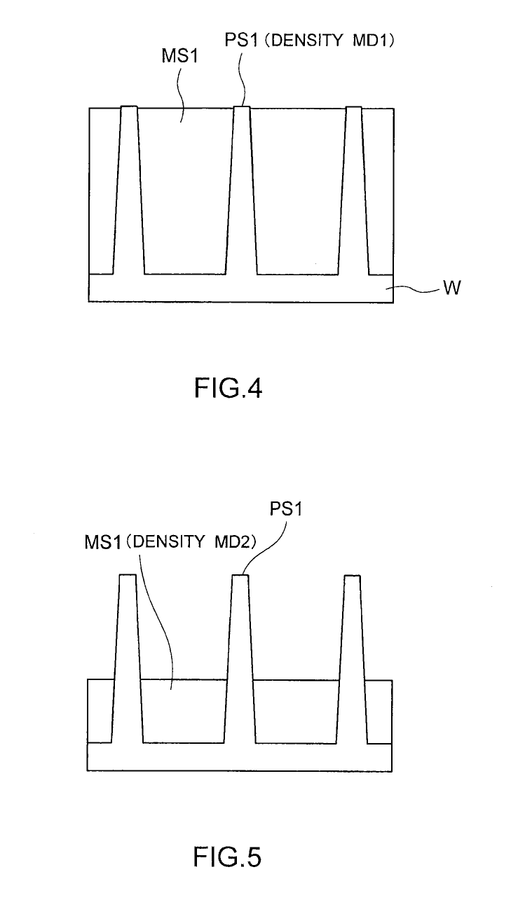

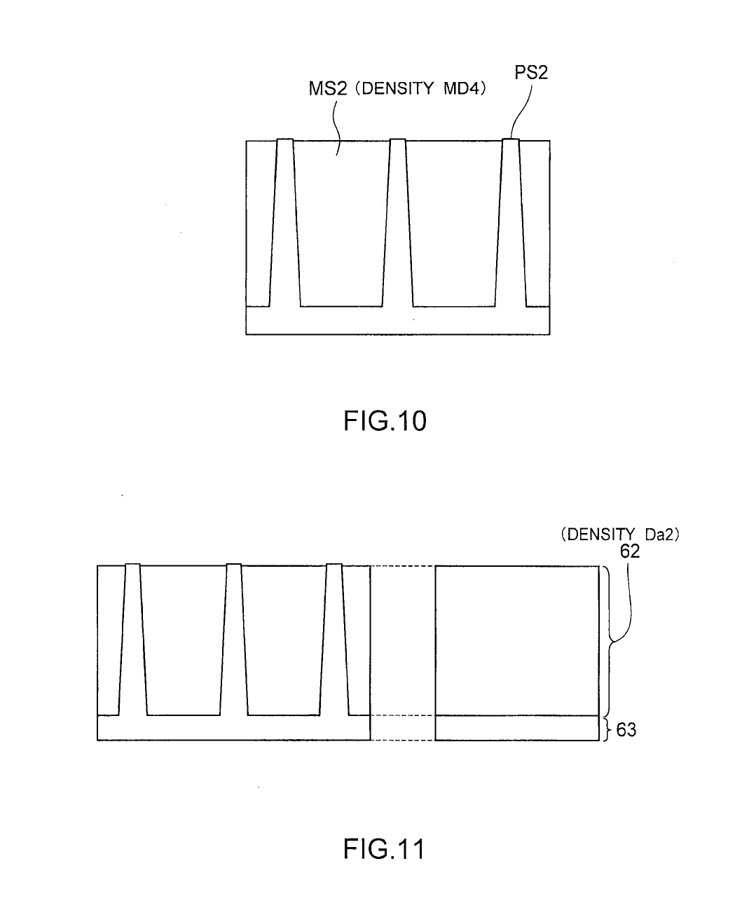

A wafer W is mounted on the upper surface of the stage 2, and the stage 2 supports the wafer W. The wafer W is provided with a sample S (see FIG. 4, FIG. 5, FIG. 9, and FIG. 10) including periodic structures PS1 and PS2 and membranous structures MS1 and MS2 in a width direction. In the present specification, the sample S used as a measurement target includes a sample before fabricated by a plurality of processes and a sample after fabricated, and measurement is performed over a plurality of processes.

Receiving a control signal from the stage controller 13, the stage 2 moves the wafer W in an X-Y-Z three-dimensional space in accordance with an unshown actuator, and also rotates the wafer W by an arbitrary rotation angle.

FIG. 2 is a plan view showing the relationship between the path of X-rays and the direction of a line pattern of the periodic structure PS. In the present embodiment, the wafer W corresponds to, for example, a substrate. The substrate includes, but not limited to the wafer W, for example, a glass substrate, a compound semiconductor substrate, and a ceramic substrate.

The X-ray tube 4 includes a light source and a concave mirror (not shown). The light source is not particularly limited to anything as long as the light source generates X-rays. In the case described in the present embodiment, for example, Ka-rays of Cu are used as a light source.

Receiving a control signal from the light source controller 11, the X-ray tube 4 generates X-rays Li having a wavelength of, for example, 1 nm or less. The optical path of the generated X-rays Li is adjusted by the concave mirror (not shown) in the X-ray tube 4, and the X-rays Li are applied to the sample S at a desired elevation angle α (see FIG. 1). In the present embodiment, the X-ray tube 4 and the light source controller 11 correspond to, for example, an electromagnetic wave applying unit.

Receiving a control signal from the goniometer controller 15, the goniometer 5 adjusts the value of the elevation angle α of the X-rays Li together with the concave mirror (not shown). The elevation angle α selected for the CD-SAXS measurement is an angle of 1° or less at which the X-rays Li are totally reflected without penetrating the wafer W, and is preferably 0.2° or less. For the XRR measurement, the goniometer 5 changes the elevation angle α between 0 degrees and 10 degrees at every angular interval during the application of the X-rays Li so that the incidence angle is equal to the reflection angle. Accordingly, the X-rays enter perpendicularly to the line direction of the periodic structure PS of the sample S from the point of the coherence length thereof.

A movable arm may be provided instead of or together with the goniometer 5 to adjust the elevation angle α. In the present embodiment, the goniometer 5 and the goniometer controller 15 correspond to, for example, angle control unit.

The monochromator 6 only extracts a desired wavelength component from the X-rays Li generated by the X-ray tube 4. As a result, the X-rays Li are changed to a monochromatic parallel beam and applied to the wafer W.

The attenuator 7 damps, to desired intensity, X-rays Lo reflected by the sample S to which the X-rays Li have been applied.

The two-dimensional detector 3 is located well apart from the periodic structure PS. The two-dimensional detector 3 detects, with light receiving elements, the X-rays Lo scattered by the sample S to which the X-rays Li have been applied, or the X-rays Lo which have been reflected by the sample S and adjusted to proper intensity by the attenuator 7, and the two-dimensional detector 3 measures the intensity of the X-rays Lo.

The light receiving elements are two-dimensionally arranged in the light receiving unit of the two-dimensional detector 3. For the CD-SAXS measurement, each of the light receiving elements measures the intensity of the X-rays Lo diffracted by the periodic structure PS, and associates the measured intensity with its position, thereby creating a two-dimensional image of X-ray scatter intensity of the whole light receiving unit. During the measurement, the X-rays Li are applied while the stage 2 is being rotated between 0° and 10° by the actuator (not shown) in accordance with a control signal from the stage controller 13 (see FIG. 2). Therefore, the exposure by scattered X-rays continues, and the light receiving unit accumulates the continuously detected scatter intensity of the X-rays Lo.

For the XRR measurement, each of the light receiving elements of the two-dimensional detector 3 measures the intensity of the X-rays Lo which have entered and then been reflected by the sample S so that the elevation angle α is changed by the goniometer 5 within a predetermined measurement angular range of, for example, 0 degrees to 10 degrees at every predetermined angular interval. Each of the light receiving elements associates the measured intensity with its position, thereby creating a two-dimensional image of X-ray reflection intensity as the whole light receiving unit.

The data processor 12 adds up the scatter intensities measured by the light receiving elements of the two-dimensional detector 3. Thereby, the data processor 12 creates, for the CD-SAXS measurement, a two-dimensional X-ray scatter profile, and creates, for the XRR measurement, a reflectance profile including the added reflection intensities at the elevation angles α of 0 degrees to 10 degrees at the predetermined intervals adjusted by the goniometer 5.

In the CD-SAXS measurement, a taken scatter intensity image includes interference fringes which appear at an angle determined by Bragg's condition of diffraction in an azimuthal direction and an elevation angle direction. The data processor 12 divides the two-dimensional scatter intensity image in the azimuthal direction and the elevation angle direction, and calculates a scatter profile in each of the directions. Here, the profile in the azimuthal direction means a scatter profile in which the elevation angle of the incident X-rays Li is equal to the elevation angle of scattered X-rays, and the profile in the elevation angle direction means the intensity change of diffraction peaks in the elevation angle direction.

If the X-rays Li having an azimuth nearly parallel to the longitudinal direction of the line pattern and having an elevation angle of 0.2° or less are applied to the line pattern, the X-rays Li are scattered by the pattern. The scattered X-rays Ls cause interference, so that diffraction peaks appear in the scatter profile in the azimuthal direction, and an interference fringe appears in the elevation angle direction at each of the diffraction peaks.

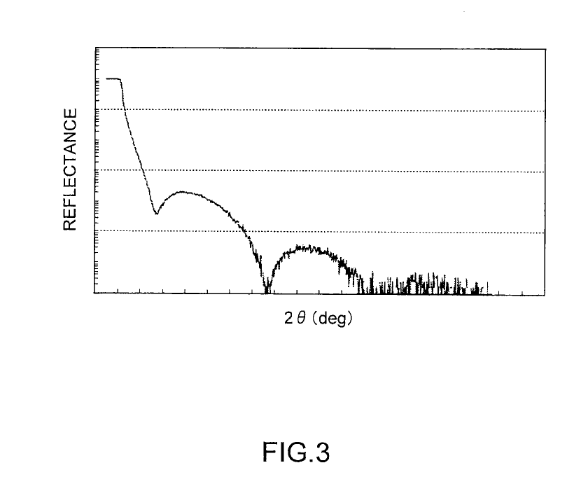

In the XRR measurement, when the sample S is constructed by a lamination of even membranes, the X-rays are reflected by the surface of the wafer W and by the interface between membranes in the periodic structure and cause interference. If the intensity is plotted at every angular interval of the elevation angle α, interference fringes varying in intensity with angle are observed, and a reflectance profile shown in FIG. 3 by way of example is obtained. The reflectance profile including the interference fringes can be acquired by calculation from optical conditions and laminated membrane information. The optical conditions in the XRR measurement include the wavelength and incidence angle (elevation angle direction) of the incident X-rays. The laminated membrane information includes thickness, interface roughness, electron density. If a path difference is calculated from the wavelength and incidence angle of the X-rays and the distance between interfaces in the laminated membrane, a reflectance profile can be found by a simulation.

Receiving the scatter profile by actual measurement from the data processor 12, the shape calculator 14 draws, from a memory MR1, the profile obtained by a simulation (hereinafter referred to as a “simulation scatter profile”) and checks the scatter profiles against each other, and performs fitting to minimize the difference therebetween. The shape calculator 14 outputs, as a measurement value of the surface shape of at least part of the periodic structure PS of the sample S, the value of a shape parameter providing the minimum fitting error, and supplies the value to the thickness/density calculator 17. In the present embodiment, the scatter profile by actual measurement corresponds to, for example, a first scatter profile, and the simulation scatter profile corresponds to, for example, a second scatter profile.

The simulation scatter profile can be obtained by calculation from the optical conditions and pattern information. More specifically, for the sample S, a section model is set from the pattern information including a sectional shape and a material and from the optical conditions, and the simulation scatter profile is found from the section model by the volume integral of the sectional shape. A previously obtained simulation scatter profile may be taken into the memory MR1, or the shape calculator 14 may create a simulation scatter profile.

The optical conditions include the wavelength and incidence angle (azimuthal direction, elevation angle direction) of the X-rays Li entering the wafer W and so on. The pattern information includes the sectional shape and the electron density. The sectional shape means the edge portion of a surface pattern, and is a function represented by shape parameters including the pitch, CD, height, wall angle, top rounding, and bottom rounding.

Receiving the measurement value of the sectional shape of the periodic structure PS from the shape calculator 14, the thickness/density calculator 17 sets an analytic model in which the periodic structure and the membranous structure are regarded as a single mixed layer, and then calculates the thickness and density of the analytic model by the XRR measurement, and further calculates, from the sectional shape of the periodic structure PS and the thickness and density of the analytic model, the density of the membranous structure (see the sign MS1 in FIG. 4 and the sign MS2 in FIG. 10) after a volume change caused through a plurality of processes. The analytic model will be described in detail later.

In the case of the XRR measurement, the thickness/density calculator 17 determines conditions for the XRR measurement including a measurement angular range and a step angle from shape information regarding the analytic model, and sends the measurement conditions to the goniometer controller 15. The thickness/density calculator 17 also controls the light source controller 11 and the stage controller 13 in accordance with the optical conditions including the wavelength of the incident X-rays, and then performs the XRR measurement. The thickness/density calculator 17 receives, from the data processor 12, a reflectance profile by actual measurement regarding the periodic structures PS1 and PS2 and the membranous structures MS2 and MS4 (hereinafter referred to as an “actual measurement reflectance profile”). The thickness/density calculator 17 then analyses the obtained actual measurement reflectance profile, and thereby calculates the (apparent) thickness and density of the mixed layer.

For the analysis, the thickness/density calculator 17 acquires a reflectance profile by a simulation regarding the analytic model (hereinafter referred to as a “simulation reflectance profile”). The thickness/density calculator 17 checks the actual measurement reflectance profile against the simulation reflectance profile, and performs fitting to minimize the difference therebetween. The thickness/density calculator 17 then finds the values of the thickness and density of the mixed layer at which the fitting error is minimized. In the present embodiment, the actual measurement reflectance profile corresponds to, for example, a first reflectance profile, and the simulation reflectance profile corresponds to, for example, a second reflectance profile. The thickness/density calculator 17 corresponds to, for example, first and second calculation units.

Furthermore, the thickness/density calculator 17 separates the densities of the periodic structures PS1 and PS2 and the membranous structures MS2 and MS4 from the (apparent) density of the mixed layer, and thereby calculates the density of the filling material that constitutes the membranous structures MS2 and MS4 after the volume change.

(2) Measurement of Density of Membranous Structure

Several examples in which the density of the membranous structure after fabrication is measured by use of the measurement apparatus shown in FIG. 1 are described in detail with reference to FIG. 4 to FIG. 10.

### (a) Example 1

An example of a sectional view of a sample S used in the present example before fabrication is shown in FIG. 4. A line-and-space periodic structure PS1 is provided on a wafer W, and a membranous structure MS1 is formed to fill the space of the periodic structure PS1. The position of the top face of the periodic structure PS1 is substantially the same as the position of the top face of the membranous structure MS1.

In the present example, the periodic structure PS is made of a first material having a density MD1, and the membranous structure MS1 is made of a second material. The density MD1 is a known value, and may be stored in a memory MR2 in advance or may be input to the thickness/density calculator 17 by an operator via, for example, an unshown user interface. The value of the density MD1 may be found by an XRR measurement using the measurement apparatus shown in FIG. 1 before the process of forming the membranous structure MS1.

FIG. 5 shows a sectional view of the sample S shown in FIG. 4 after etched to reduce the volume of the membranous structure MS1. In the present example, a density MD2 of the second material after the etching is found.

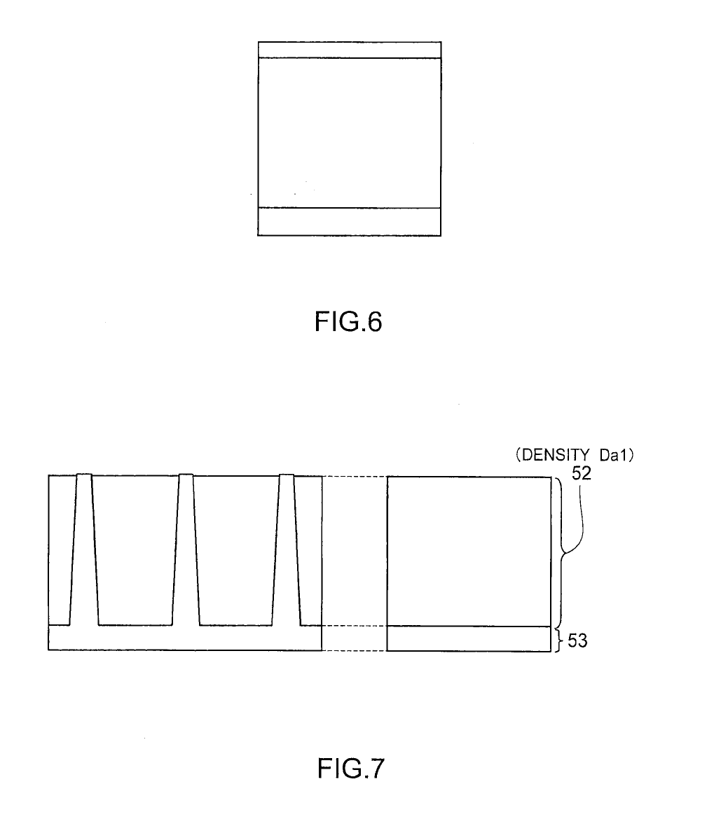

As described above, the XRR measurement is capable of finding the density and thickness of a membrane of each layer for a laminated membrane having a structure in a depth direction D alone, i.e., for a sample formed by a lamination of even membranes alone, for example, as shown in FIG. 6. However, the XRR measurement is incapable of finding the densities of the material of the line pattern and the filling material for the sample having the periodic structure and the membranous structure shown in FIG. 4.

Accordingly, in the present example, as shown in FIG. 7, a two-layer model made up of a wafer layer 53 and a line portion including a filling material is set to approximate a condition before etching. The line portion is regarded as a single mixed layer 52 without differentiation between a line and the filling material. An XRR analytic model which uses the thicknesses and densities of the layers 53 and 52 as parameters and which has a structure in the depth direction alone is set. The XRR measurement is performed in the condition shown in FIG. 4. A density Da1 of the line portion is measured by an analysis based on the analytic model shown in FIG. 7. However, the obtained density Da1 of the line portion is only the apparent density of the mixed layer 52, and it is therefore impossible to figure out a density MD2 of the filling material of the line. It requires a technique which separates the density MD1 of the first material constituting the line pattern from the density MD2 of the second material that is the filling material constituting the membranous structure MS1. This separation is performed by the thickness/density calculator 17.

The technique for exclusively separating the density MD2 of the filling material from the density Da1 of the mixed layer 52 is as follows.

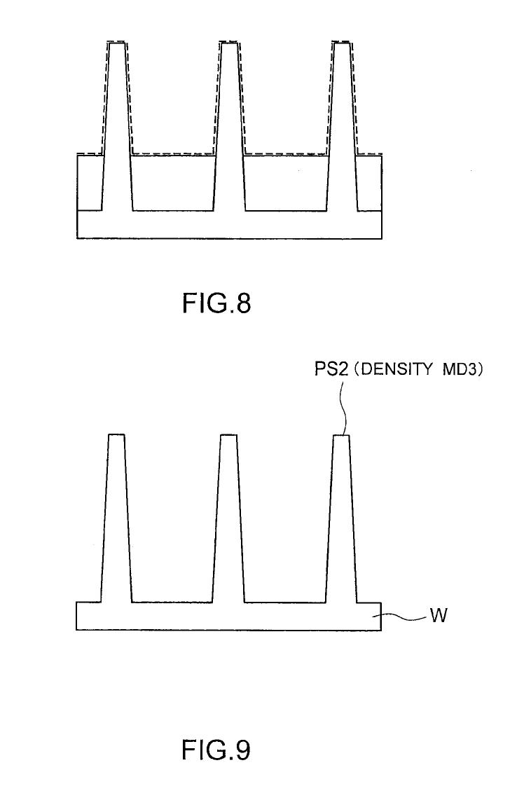

In a condition after the etching shown in FIG. 5, a part of the periodic structure PS appears in the surface. The volume ratio of the line to space here is equal to the volume ratio of the line to the filling material in the mixed layer 52 shown in FIG. 7. Therefore, as shown in FIG. 8, the shape calculator 14 uses the CD-SAXS to measure the surface shape of the sample S in the condition after etching. From this measurement result, the thickness/density calculator 17 finds a line-to-space volume ratio Rv1.

More specifically, the line-to-space volume ratio Rv1 is provided by

Rv1=VD1/VD2 Equation (1)

wherein VD2 is the volume of the filling material reduced by the etching, and VD1 is the volume of the portion corresponding to the reduction of the filling material, i.e., the line-pattern portion from the top face of the periodic structure PS1 to the surface of the residual filling material.

Once the space of the periodic structure PS has been filled with the second material, the density of the filling material does not change before and after the etching. Thus, the following relationship is made between the density Da1 of the mixed layer 52, the density MD1 of the line pattern, and the density MD2 of the filling material:

Da1=(MD1×Rv1+MD2)/(Rv1+1) Equation (2).

The thickness/density calculator 17 calculates the density MD2 of the filling material in accordance with Equation (2), and displays the density MD2 on a monitor 18 and also stores the density MD2 in the memory MR.

### (b) Example 2

FIG. 9 shows an example of a sectional view of a sample S used in the present example before fabrication. A line-and-space periodic structure PS2 that uses Si having a density MD3 as a material is provided on a wafer W.

FIG. 10 shows an example of a sectional view of the sample shown in FIG. 9 after fabrication. The space of the periodic structure PS2 is filled with Cu by a plating process so that the membranous structure MS2 is formed. Thus, a density MD4 of CU of the membranous structure MS2 after plating is the measurement target in the present example. The membranous structure MS2 is used in, for example, a metallic wiring line.

First, the shape calculator 14 performs a CD-SAXS measurement at the stage shown in FIG. 9 before plating, and measures the surface shape of the periodic structure PS2.

The shape calculator 14 then calculates a line-to-space volume ratio Rv2 in the periodic structure PS2 from the parameter of the obtained surface shape, and provides the volume ratio Rv2 to the thickness/density calculator 17 together with the parameter of the surface shape. Rv2 is provided by

Rv2=VD3/VD4 Equation (3)

wherein VD3 is the volume of the line of the periodic structure PS, and VD4 is the volume of the space.

The thickness/density calculator 17 sets an analytic model for the XRR measurement as shown in FIG. 11 from the provided parameter of the surface shape. In the model shown in FIG. 11, a layer 63 of the wafer portion and a line portion 62 including the filling material are piled up to approximate a condition after plating. The line portion 62 is regarded as a single mixed layer without differentiation between Si and Cu. This provides an analytic model which uses the thicknesses and densities of the wafer portion 63 and the line portion 62 as parameters and which has a structure in the depth direction alone. Here, the thickness/density calculator 17 uses, as the volume ratio between Si and Cu, the line-to-space volume ratio Rv2 calculated by the shape calculator 14 without change.

The XRR measurement is then performed in the condition after plating shown in FIG. 10, and a density Da2 of the line portion (mixed layer) 62 is measured by the thickness/density calculator 17.

Finally, the thickness/density calculator 17 uses the following relational expression to separate the density of each material from the apparent density Da2 of the mixed layer 52, and thereby calculates the density MD4 of Cu filling the space in the periodic structure PS2:

Da2=(MD3×Rv2+MD4)/(Rv2+1) Equation (4).

In the present example as well, the density used as the density MD3 is input by the operator as the known value, or has been stored in and is then drawn from the memory MR, but the density MD3 is not limited thereto. The density MD3 may be found by the XRR measurement as pre-processing of measurement.

The measurement apparatus according to at least one of the embodiments described above includes the thickness/density calculator 17. The thickness/density calculator 17 sets the analytic model including the line portion which is regarded as a single mixed layer without differentiation between the line and the filling material, and calculates the thickness and density of the line portion by the XRR measurement. The thickness/density calculator 17 uses the surface shape obtained by the CD-SAXS to exclusively separate the density of the filling material from the apparent density of the line portion. Consequently, it is possible to measure the density of the filling material with high accuracy.

Although the CD-SAXS function of the measurement apparatus is used for the measurement of the surface shape of the sample S in the above explanation, this is not a limitation. It is also possible to find the density of the filling material by measuring the surface shape of the sample S using, for example, an AFM outside the measurement apparatus and providing the obtained shape parameter to the thickness/density calculator 17. In this case, the shape calculator 14 is unnecessary in the configuration shown in FIG. 1, and the signal from the data processor 12 is sent to the thickness/density calculator 17.

(B) Measurement Method

### (1) Embodiment 1

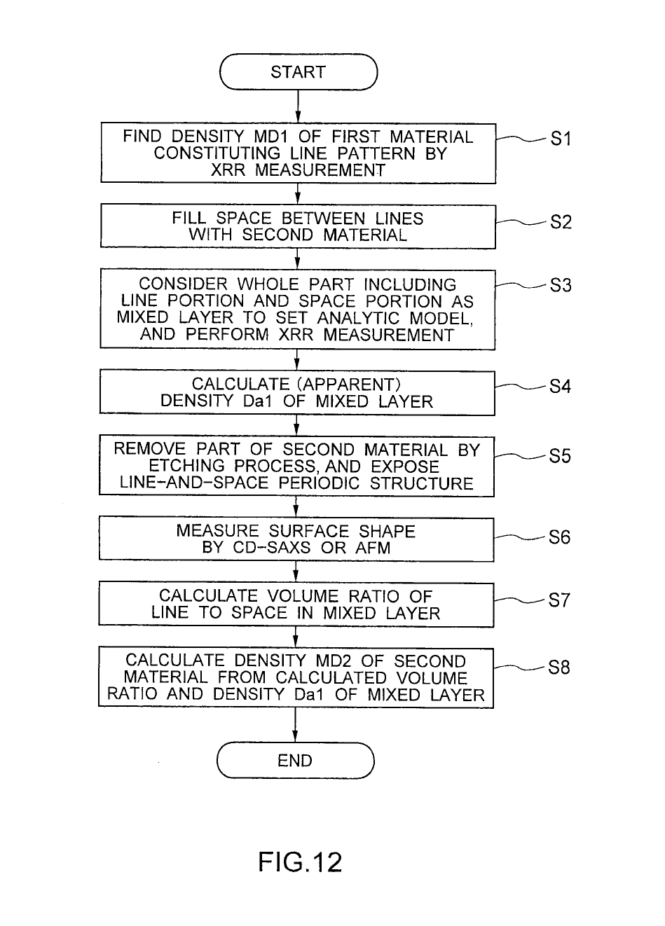

A measurement method according to Embodiment 1 is described with reference to a flowchart in FIG. 12. A structure shown in FIGS. 4 and 5 is taken up as the sample S. FIG. 4 shows the structure before fabrication and FIG. 5 shows the structure after fabrication. The measurement target is the density MD2 of the filling material constituting the membranous structure MS1.

First, the density MD1 of the first material constituting the line pattern of the sample S is found by the XRR measurement at a stage before the periodic structure PS1 is filled with the filling material to form the membranous structure MS1 (step S1). As the density MD1 of the first material does not change before and after fabrication, a value measured in advance may be used.

The space between the lines is filled with the second material, and the membranous structure MS1 shown in FIG. 4 is thereby formed (step S2).

Then the whole part including the line portion and the space portion above the wafer W is regarded as the mixed layer to set an analytic model (see FIG. 7). The XRR measurement is performed (step S3). The apparent density Da1 of the mixed layer 52 is calculated (step S4).

Part of the filling material is then removed by etching in a direction horizontal to the upper surface of the wafer W, i.e., uniformly in the depth direction, and the surface portion of the periodic structure PS1 is thereby exposed (step S5, see FIG. 5).

In this condition, the shape of the exposed surface portion is measured by the CD-SAXS or the AFM (step S6), and the volume ratio of the line to space in the mixed layer 52 is calculated (step S7).

Finally, Equations (1) and (2) described above are used to calculate the density MD2 of the filling material from the calculated volume ratio and the apparent density Da1 of the mixed layer 52 (step S8).

### (2) Embodiment 2

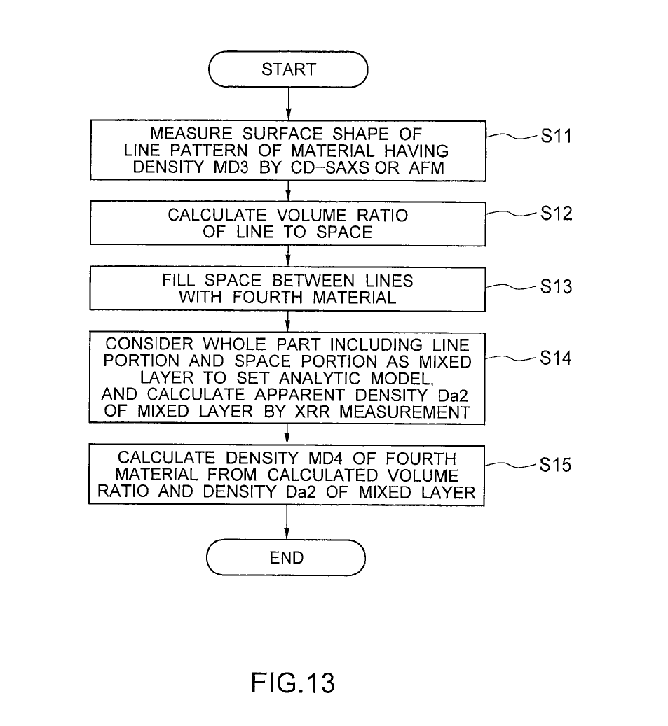

A measurement method according to Embodiment 2 is described with reference to a flowchart in FIG. 13. A structure shown in FIGS. 9 and 10 is taken up as the sample S. FIG. 9 shows the structure before fabrication and FIG. 10 shows the structure after fabrication. The measurement target is the density MD4 of the filling material constituting the membranous structure MS2.

First, the surface shape of the line pattern (density MD3) of Si at a stage before fabrication shown in FIG. 9 is measured by the CD-SAXS or the AFM (step S11), and the volume ratio of the line to space in the periodic structure PS2 is calculated (step S12). Although the known value is used as the density MD3 of Si is used here, the density MD3 of Si may be found by the XRR measurement as pre-processing. In the present embodiment, Si corresponds to, for example, a third material.

As shown in FIG. 10, the space between the lines is filled with Cu by plating (step S13). In the present embodiment, Cu corresponds to, for example, a third material.

Furthermore, the whole part including the line portion and the space portion above the wafer W is regarded as the mixed layer 62 (see FIG. 11) to set an analytic model. The apparent density Da2 of the mixed layer 62 is calculated by the XRR measurement (step S14).

Equations (3) and (4) described above are used to calculate the density MD4 of Cu from the calculated volume ratio Rv2 and the apparent density Da2 of the mixed layer 62 (step S8).

In the measurement method according to at least one of the embodiments described above, the analytic model including the portion which is regarded as a single mixed layer without differentiation between the line and the filling material is set, and the thickness and density of the mixed layer is calculated by the XRR measurement. The surface shape obtained by the CD-SAXS is used to exclusively separate the density of the filling material from the apparent density of the line portion. Consequently, it is possible to measure the density of the filling material with high accuracy.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A measurement apparatus comprising:
a stage configured to hold a substrate, the substrate comprising a periodic structure of a first material arranged in a direction horizontal to a main surface of the substrate, and a membranous structure which is made of a second material different from the first material to fill the periodic structure and which changes in volume in a depth direction in accordance with a process;
a stage control unit configured to control at least one of a position, height, and rotation angle of the stage;
an electromagnetic wave applying unit configured to generate electromagnetic waves and apply the electromagnetic waves to the substrate;
an angle control unit configured to control an incidence angle of the electromagnetic waves from the electromagnetic wave applying unit;
a detector configured to detect the electromagnetic waves scattered or reflected by the substrate and measure the intensity of the electromagnetic waves;
a first calculation unit configured to process a signal from the detector to create a first reflectance profile, fit the first reflectance profile to a second reflectance profile prepared by a simulation, and thereby calculate thickness and density of an analytic model which is set so that the periodic structure and the membranous structure are regarded as a single mixed layer; and
a second calculation unit configured to calculate, from a sectional shape of the periodic structure and the calculated thickness and density, the density of the second material after a volume change.

2. The apparatus of claim 1, further comprising:
a shape calculation unit configured to process a signal from the detector to create a first scatter profile, fit the first scatter profile to a second scatter profile prepared by a simulation, and thereby calculate the sectional shape of the periodic structure.

3. The apparatus of claim 1,
wherein the process comprises a process of filling a space of the periodic structure with the second material, and
a process of removing part of the second material by etching to form the membranous structure, and
when Rv1=(VD1/VD2), the second calculation unit calculates MD2 from the following equation:
Da1=(MD1×Rv1+MD2/(Rv1+1)
in which MD1 is the density of the first material, MD2 is the density of the second material after the filling, VD2 is the volume of the second material reduced by the fabrication, Da1 is the density of the mixed layer of the analytic model, and VD1 is the volume of a part of the periodic structure corresponding to the second material reduced by the fabrication.

4. The apparatus of claim 1,
wherein the process comprises a process of filling a space of the periodic structure with the second material by plating, and
the second calculation unit calculates MD4 by using following equation:
Da2=(MD3×Rv2+MD4)/(Rv2+1) Equation (4)
in which MD3 is the density of the first material, MD4 is the second density of the filled membranous structure, VD4 is the volume of the second material of the membranous structure, Da2 is the density of the mixed layer of the analytic model, and Rv2 is the volume ratio of the periodic structure to the membranous structure.

5. A measurement method comprising:
applying electromagnetic waves to a substrate while changing an elevation component of an incidence angle, the substrate comprising a periodic structure of a first material arranged in a level direction, and a membranous structure in a depth direction formed by filling the periodic structure with a second material different from the first material;
measuring an intensity of the electromagnetic waves reflected by the substrate in response to the application of the electromagnetic waves;
regarding the periodic structure and the membranous structure as a single mixed layer to set an analytic model;
creating a first reflectance profile from the measured intensity, fitting the first reflectance profile to a second reflectance profile prepared by a simulation, and thereby calculating the thickness and density of the set analytic model;
measuring the surface shape of the periodic structure for the substrate fabricated to reduce the volume of the second material; and
calculating the density of the second material after the fabrication from the density of the first material, the measured surface shape, and the calculated thickness and density.

6. The measurement method of claim 5, further comprising applying electromagnetic waves to the substrate while changing an azimuth component of the incidence angle,
wherein the surface shape of the periodic structure after the fabrication is measured by creating a first scatter profile from the measured intensity and fitting the first reflectance profile to a second reflectance profile prepared by a simulation.

7. The measurement method of claim 5,
wherein the surface shape of the periodic structure after the fabrication is measured by use of an atomic force microscope.

8. The measurement method of claim 5, further comprising
applying electromagnetic waves to the substrate before the periodic structure is filled with the second material while changing an elevation component of an incidence angle;
measuring the intensity of the electromagnetic waves reflected by the substrate in response to the application of the electromagnetic waves; and
creating a third reflectance profile from the measured intensity, and fitting the third reflectance profile to a fourth reflectance profile prepared by a simulation, and thereby calculating the density of the first material.

9. The measurement method of claim 5,
wherein when Rv1=(VD1/VD2), MD2 is calculated from the following equation:
Da1=(MD1×Rv1+MD2/(Rv1+1)
in which MD1 is the density of the first material, MD2 is the density of the second material after the filling, VD2 is the volume of the second material reduced by the fabrication, Da1 is the density of the mixed layer of the analytic model, and VD1 is the volume of a part of the periodic structure corresponding to the second material reduced by the fabrication.

10. A measurement method comprising:
measuring a sectional shape of a periodic structure which is arranged in a level direction and is formed on a substrate with a first material;
applying electromagnetic waves to a substrate while changing an elevation component of an incidence angle, a membranous structure being further formed in the substrate to fill the periodic structure with a second material different from the first material;
measuring the intensity of the electromagnetic waves reflected by the substrate in response to the application of the electromagnetic waves;
setting an analytic model in which the periodic structure and the membranous structure are regarded as a single mixed layer;
creating a first reflectance profile from the measured intensity, fitting the first reflectance profile to a second reflectance profile prepared by a simulation, and thereby calculating the thickness and density of the set analytic model; and
calculating the density of the second material after the filling from the measured surface shape and from the calculated thickness and density.

11. The measurement method of claim 10, further comprising applying electromagnetic waves to the substrate while changing an azimuth component of the incidence angle,
wherein the surface shape of the periodic structure is measured by creating a first scatter profile from the measured intensity and fitting the first reflectance profile to a second reflectance profile prepared by a simulation.

12. The measurement method of claim 10,
wherein the surface shape of the periodic structure after the fabrication is measured by use of an atomic force microscope.

13. The measurement method of claim 10,
wherein MD4 is calculated from the following equation:
Da2=(MD3×Rv2+MD4)/(Rv2+1) Equation (4)
in which MD3 is the density of the first material, MD4 is the second density of the filled membranous structure, VD4 is the volume of the second material of the membranous structure, Da2 is the density of the mixed layer of the analytic model, and Rv2 is the volume ratio of the periodic structure to the membranous structure.
